(19) United States
(12) Patent Application Publication
(10) Pub. No.: US 2012/0209694 A1
(43) Pub. Date: Aug. 16, 2012

(54) VIRTUAL COMMUNICATION PLATFORM

(75) Inventors: Sanjay KUNCHAKARRA, Clarksville, MD (US); Sohum Dalal, Silver Spring, MD (US); Neil S. Davey, Gaithersburg, MD (US); Robert Hankins, Washington, DC (US)

(73) Assignee: The Swap Hub LLC, Gaithersburg, MD (US)

(21) Appl. No.: 13/455,133

(22) Filed: Apr. 25, 2012

Related U.S. Application Data
(60) Provisional application No. 61/556,205, filed on Nov. 5, 2011.
(60) Provisional application No. 61/625,949, filed on Apr. 18, 2012.

(51) Int. Cl. G06F 3/01; G06Q 30/00

(52) U.S. Cl. 705/14.41; 715/753; 715/756; 705/14.49

(57) ABSTRACT

According to various aspects, a method and system provides a collaborative platform comprising performing a collaborative interactive session for a plurality of members, wherein some or all of the plurality of members interact from different human interaction platforms.

### CROSS-REFERENCE TO RELATED APPLICATIONS

This application claims benefit from U.S. Provisional application Ser. No. 61/556205, entitled “SWAP: FUTURE OF VIDEO CHATTING,” filed on Nov. 5, 2011, and U.S. Provisional application Ser. No. 61/625949, entitled “SWAP[:] The Next Generation of Virtual Communication Platform,” filed on Apr. 18, 2012, which are incorporated herein in their entirety by reference. This application is also related to the U.S. patents and publications listed in Appendix 1. These U.S. patents and publications listed in Appendix 1 are incorporated herein in their entirety by reference.

### BACKGROUND

According to International Data Corporation (IDC), a global provider of market intelligence, video communications is one of the most promising industries with the potential to create a market of at least 150 million people in America alone in the next five years.

Certain video communication platforms for groups of individuals to create and share information, interact with each other through the software and generally use the software to achieve an individual or group objective are currently available. Generally these systems store the collaboration for future reference and further discussion or collaboration. However, these systems have several limitations that have been addressed herein. Also, novel solutions for these limitations are provided herein.

### SUMMARY

The embodiments herein relate to a method of establishing a collaborative platform comprising performing a collaborative interactive session for a plurality of members, wherein some or all of the plurality of members from different human interaction platforms interact with each other via the collaborative platform. The method could further comprise initiating collaborative interactive session that comprises initiating multiple collaborative interactive sessions.

The method could further comprise accessing the collaborative interactive session in a manner such that a person or system can access an event from the collaborative interactive session in substantially less time than a duration of the collaborative interactive session.

The method could further comprise displaying of targeted advertisements or notifications based on the context of the interactive collaborative sessions.

The method could further comprise measuring effectiveness of the displaying of targeted advertisements or notifications.

The members of different multiple collaborative interactive sessions could be isolated from each other while each member has a capability to simultaneously maintain the multiple collaborative interactive sessions.

The method could further comprise integrating an application or a device within the collaborative interactive session.

Another embodiment relates to a computer implemented system comprising a storage medium configured to store a collaborative interactive session data; and a processor configured to perform a collaborative interactive session for a plurality of members, wherein some or all of the plurality of members from different human interaction platforms interact via the collaborative interactive session. The computer implemented system could further comprise social media platforms.

The system could be configured to initiate the collaborative interactive session in a manner such that a person or system can access an event from the collaborative interactive session in substantially less time than a duration of the collaborative interactive session.

The system could comprise a sound and/or video hub, wherein the sound and/or video hub allows any member of the plurality of the members to play a song and/or a video and simultaneously allows some or all of the plurality of members to listen and/or watch the song and/or the video played.

The system could comprise audio and/or video synopsis of the collaborative interactive session for the plurality of members using a sound and image-processing technology that creates a summary of an original full length audio and/or video.

The processor could be configured to initiate collaborative interactive session that comprises initiating multiple collaborative interactive sessions.

The processor could be configured to display targeted advertisements or notifications based on the context of the interactive collaborative sessions.

The processor could be configured to measure effectiveness of the displaying of targeted advertisements or notifications.

The processor could be configured to integrate an application or a device within the collaborative interactive session.

Another embodiment relates to a tangible non-transitory computer readable medium comprising computer executable instructions executable by one or more processors for establishing a collaborative platform comprising performing a collaborative interactive session for a plurality of members, wherein some or all of the plurality of members interact from different human interaction platforms. The performing the collaborative interactive session could comprise initiating multiple collaborative interactive sessions.

The tangible non-transitory computer readable medium could further comprise computer executable instructions executable by one or more processors for accessing the collaborative interactive session in a manner such that a person or system can access an event from the collaborative interactive session in substantially less time than a duration of the collaborative interactive session.

The tangible non-transitory computer readable medium could further comprise computer executable instructions executable by one or more processors for displaying of targeted advertisements or notifications based on the context of the interactive collaborative sessions.

The tangible non-transitory computer readable medium could further comprise computer executable instructions executable by one or more processors for measuring effectiveness of the displaying of targeted advertisements or notifications.

The foregoing summary is illustrative only and is not intended to be in any way limiting. In addition to the illustrative aspects, embodiments, and features described above, further aspects, embodiments, and features could become apparent by reference to the drawings and the following detailed description.

### BRIEF DESCRIPTION OF THE FIGURES

FIG. 1 shows the flow diagram of a virtual communication platform system when a user starts a login session.

FIG. 2 shows a system having collaboration platform, user sessions and social network platform interaction.

FIG. 3 shows a schematic of a collaborative session on a virtual communication platform system.

FIG. 4 shows a schematic of the conceptual architecture of a virtual communication platform system.

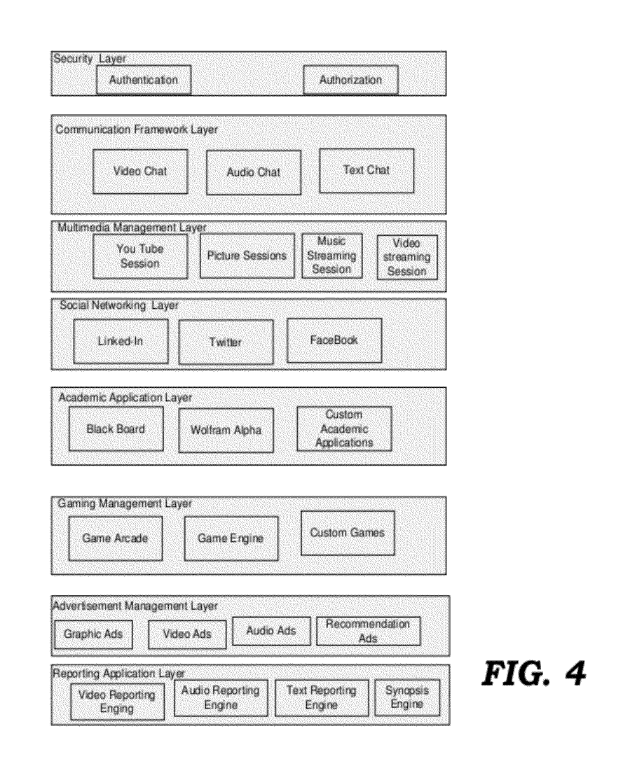

FIG. 5 shows a schematic of a logical architecture of a virtual communication platform system.

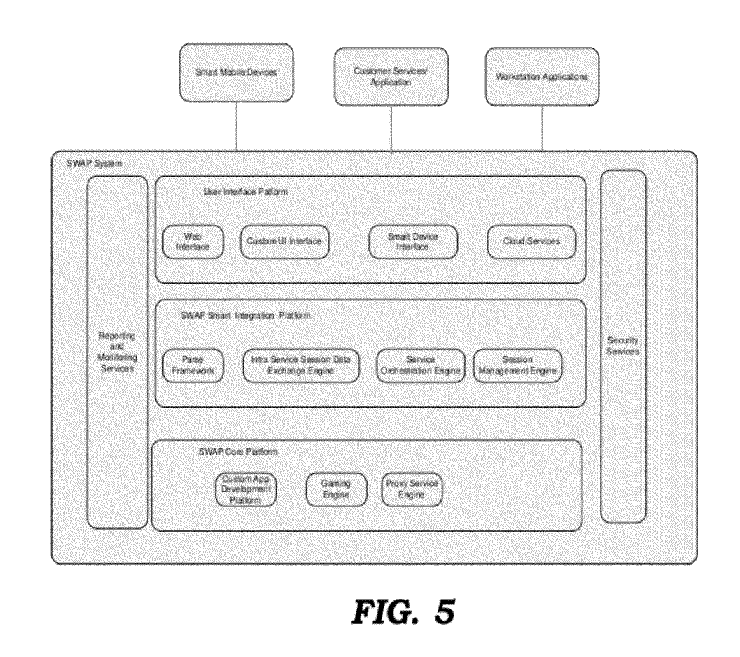

FIG. 6 shows software deployed on cloud infrastructure.

### DETAILED DESCRIPTION

SWAP is the acronym of an embodiment of a virtual communication platform system described herein. SWAP and a virtual communication platform system are used synonymously in this application.

Embodiments herein relate to SWAP, which could be a web-based application that serves as a multi-dimensional platform for peer-to-peer communication. Current video communication services such as Skype only provide basic face-to-face contact pathways—the interaction is limited to text, audio, and video. SWAP integrates collaboration with communication. It streamlines the base services of peer-to-peer text, audio and video communication with interaction on various collaborative platforms as well as with individual web-based activity. SWAP could incorporate existing streams of social media.

SWAP strives to be the global leader in providing a unified collaboration platform using Internet communication media while enhancing the capabilities of virtual interaction of people from all walks of life. SWAP could provide young adults with a video communications application that integrates multiple streams of online media with virtual interaction. SWAP could provide a unified platform that allows users of any social media service, such as Facebook or Google+, to interact on, removing the fragmentation within social media communication. This platform also combines text, audio, and video communication with collaboration in the areas of academia, music, and recreational activities such as gaming, extending the capabilities of current virtual communication. This application could be organized into several spheres of interaction known as “globes”. Each globe could provide a base interaction for multiple users to collaborate. Our application could integrate these collaboration platforms with a video feed to enhance overall virtual interaction.

Young adults under the age of thirty are the heaviest users of video data, however current services such as Skype and Oovoo aren't providing this market with a medium through with they can interact beyond basic dialogue. This has allowed the inventors an extremely favorable opportunity that SWAP could take advantage of by providing a platform that solves issues of fragmentation in current communication and collaboration services. SWAP could also take advantage of recent technological developments in bandwidth growth and cloud computing, streamlining the transfer of information that had plagued video communication platforms in the past.

Communication Platform refers to a platform that establishes virtual peer-to-peer interaction through text, audio, and video mediums among others.

Collaboration Platform refers to a platform that hosts a plurality of users, who interact co-dependently to accomplish a task

Globe refers to a virtual communication platform's interface organized into spheres of interaction or “globes”. Each globe could represent or provide a base interaction for multiple users to utilize and interface. The type of services provided by each base interaction differentiate each globe, may it be categorized as academic, recreational or social.

The user's interface could be customizable to the user's preference. Based on his or her interests, involvements or activities, the user could be able to select the globes—and the platforms of interaction that each represent--that pertain to themselves, and add the selected globes to his or her own personalized interface. At the inception of the product, several pre-established or default globes could be available for use, such as the Chalkboard, Arcade, SoundHub, and Clubhouse. However, much like current mobile operating systems such as iOS and android, SWAP could allow for users to create and publish their own globes for private or public use. Much like current app stores, these globes can be put up for sale, or can be available for free use.

Chalkboard refers to a feature in a virtual communication platform such as SWAP. The chalkboard could integrate academic interaction with peer-to-peer communication. Emulating a classroom atmosphere, the platform could allow video communication between multiple users and could provide virtual tools to facilitate academic interaction, much like modern blackboard applications. However, unlike most services such as WebEx that provide limited blackboard based video communication, the chalkboard globe could service specific forms of academic interaction geared towards our target audience, an age demographic that has never been targeted by blackboard based communication services. The chalkboard could facilitate academic interaction in multiple domains differentiated by individual academic disciplines. Each domain could have specific tools and services that cater to the particular subject. For example, the physics domain could have tools to create diagrams for physical representations and an equation recognition system that could assist with working through mathematical steps. On the opposite end of the spectrum, the language or English domain could consist of literature based search engines as well as group editing tools.

SWAP could include the capabilities of software programs like paint that require users to draw, create visual diagrams, or write letters and numbers using a computer mouse. SWAP could harness the capabilities of mobile and tablet technology as well as its touch screen technology to allow users to interact with the chalkboard through a much more seamless and natural medium. Furthering this concept of seamless, SWAP could incorporate handwriting recognition software that could be able to decipher and identify what the user is writing based on the domain selected and the context of the information already present, to convert the user's handwriting into digital text that could appear much more legible and clear to all the users.

SWAP could include tutoring services, such as peer to peer tutoring, connecting college students with high school students. Instead of working together through one platform, wherein the tutors and students could often have to open up Skype, Google docs and sometimes even hold textbooks up to the camera to demonstrate a topic or concept as in the current systems for collaboration and communication are not effective in servicing this sort of academic interaction, SWAP could be able to provide tutoring services through multiple platforms, allowing for a much more holistic and accessible form of online tutoring.

Arcade refers to online gaming. Online gaming has become a fast paced and growing industry in the past few years. Most of these games, such as World of Warcraft and League of Legends, are team based multiplayer games. The level of collaboration has already been established between the users however, the gaming platforms, have not considered improving the communication dynamic between the players. Instead of simply watching one another's virtual presences, video communications could be utilized to show both the user and his digital manifestation, bringing a much more personal and human element to the game. SWAP could bring the communication aspect to the gaming world with the Arcade globe. Similar to mobile app stores, the Arcade globe could consist of a selection of games to choose from and a user could be able to play that game with whomever he or she chooses to play with. The game could then begin, with a sidebar displaying all of the user's video feed. The game could then become characterized by real time emotion and personal interaction tied in with the digital action present within the game.

The games available for use in the Arcade globe could not only be a product of SWAP, but can be supplied by the users themselves. Toolkits could be provided to any user who hopes to design or create a game that could become available for use in the Arcade. The created applications could be supplied for free or for a fee.

SoundHub refers to a hub for uploading and downloading digital media such as music, video, and pictures. With the advent of iTunes, the purchase and distribution of music has become much more accessible. And because of such accessibility, music sharing has become much more prevalent. However, the social experience of listening to music has not been introduced to the digital world. Music was shared among friends and became a centerpiece in social interaction. However there is fragmentation that prevents this same social experience from entering the online world. The SoundHub globe could allow the user to upload his or her music from platforms such as Win Amp or ITunes that could create a temporary library for a plurality of users to access and listen together. Current video communication services provide no such avenues for music sharing and can only take place when one user plays a song, the audio emitted from his speakers could then be transmitted through the microphone and only then can another person listen to the same song in real time. However there are great flaws with this method. Only one user has control over the audio being played and once the audio is transmitted through speakers and then a microphone, the quality becomes substantially lowered and is disrupted by various sources of noise. The SoundHub essentially becomes a group iTunes platform, with the actual audio file available to all users.

ChatHub refers to a cross platform between multiple social networks and Internet communications mediums. The ChatHub could service a groundbreaking form of web communication. Most video communication platforms allow you to import contacts from various sources such as you email. However not all these contacts can be used, unless those users themselves have an account in the same video communications platform. Essentially, through the same pathways that video communication platforms such as Oovoo can access the information of all one's contacts, SWAP could go beyond and access that information to create a profile within the SWAP database so that users can communicate without having accounts in the same platform. For example, a SWAP user can invite his friend, a member of Gchat, to chat on the SWAP platform. The Gchat user could login to the SWAP application using his Gchat login information. SWAP could then access the information stored in Gchat's database and create a profile within the SWAP database for the Gchat user to use. Essentially, people from all different platforms can communicate through the SWAP application without having a prior active account on the SWAP platform.

SWAP's technical architecture could be such that SWAP could fully utilize cloud architecture in the following aspects.

Infrastructure as a Service (IaaS): The SWAP system could be hosted on industry proven cloud platform such as Amazon cloud. This could enable SWAP engineers to provision computing capacity through virtualization. This could enable SWAP to have unlimited amount of computing capacity as the demand increases.

Platform as a Service (PaaS): The SWAP system could be developed on standard platforms hosted by cloud providers. To begin with, SWAP could be developed on open source platforms including Apache Web Servers, Apache Tomcat, and Postgres databases. In addition, it could fully utilize the latest distributed computing platforms such as Apache Hadope hosted on Amazon EC2 cloud.

Software as a Service (SaaS): The SWAP system could be architected and designed from the ground up as Software as a Service so that multiple user groups and segments can share the same software without encountering any issues of privacy and security.

### Examples

Embodiments relate to a collaborative platform. SWAP platforms collaboration among members of different human interaction platform includes at least the following two scenarios:
1. Members forms different platforms can use their own respective communication and/or collaborative platforms and SWAP system will mediate the communication and collaboration sessions to provide a unified experience.
2. Members from different platforms can use their own credentials associated with their respective communication/collaboration platforms but are actually logging into the SWAP system software. In this scenario, all members are actually using SWAP communication and/or collaboration platform for their interaction.

The embodiments cover both of the above mentioned interaction scenarios as well as other scenarios.

An example of the SWAP system could be video chatting for virtual student classroom. A high level system flow associated with the collaboration platform can be summarized as below

If an authorized user accesses the system based on user preferences the services offered by the system are displayed. If the user's authentication and/or authorization fails the user will be denied access to the system. The SWAP system will have the flexibility to authenticate users using other collaboration platform network credentials. This feature will allow users from multiple collaboration platforms establish communication pathways.

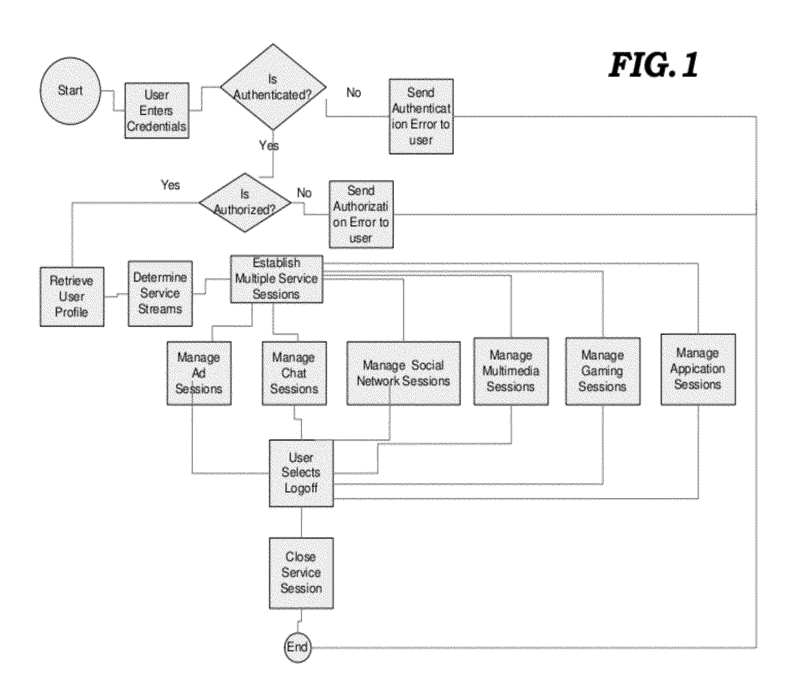

FIG. 1 shows the flow diagram of the SWAP system when a user starts a login session. The highlights of the logical flow of the system include, for example, some or all of the following features:
1. A user accesses the systems by typing an URL in the browser or initiating an application on a computer system.
2. User is challenged with credentials and enters the credentials and the credentials are submitted to the application
3. User credentials are authenticated. If authentication is successful, the user will be verified to inspect if he is authorized to access the resource. If the authorization is successful then the resource associated with collaboration platform will be displayed to the user
4. If the authentication fails the application session will end
5. If the authorization is successful but authorization fails the application session will end.

On successful authentication, the system retrieves user profiles and preferences. The set of preferences indicated by the user will determine the types of services to be displayed to the user. If the user's preferences include audio and video chat sessions and not a white board session, the user will only get audio and video chat session experience

Another embodiment relates to Users' Collaboration Sessions. This embodiment herein describes interaction between users associated with multiple platforms.

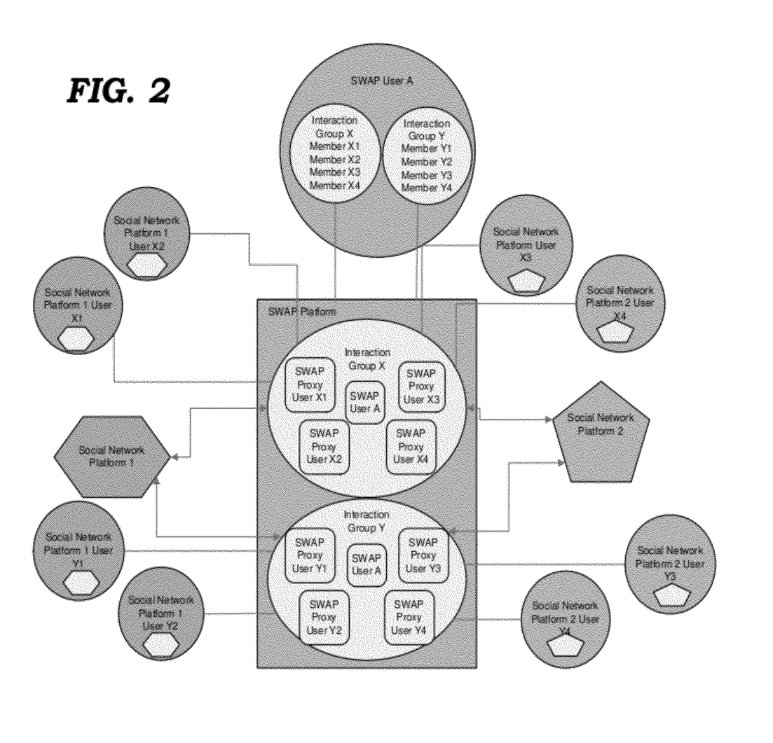

FIG. 2 illustrates an example collaborative session(s) established on the SWAP platform. FIG. 2 shows that Users associated with multiple collaborative platforms can establish communication channels and collaborate seamlessly. This feature is unique to the SWAP system.

The highlights of the user session interaction between a SWAP user and the user's from other social media platforms can include some or all of the following features:
3. SWAP Platform User A logs in to the platform. The profile contains two interactive groups X and Y. Each group has multiple users. Group X has X1 and X2 users belonging to social network platform 1 and X3 and X4 belonging to Social Network Platform 2. Similarly Group Y contains Y1 and Y2 belonging to Social Network Platform 1 and Y3 and Y4 belonging to Social Network Platform 2.
4. Any user from social network platform 1 or 2 can login to SWAP through their respective credentials associated with the social network platform.
5. FIG. 2 illustrates that SWAP User A can interact with two distinct groups i.e. Group X and Group Y concurrently. Each Group consists of members belonging to different social media networks.
6. The interaction area X and interaction Y can include multiple resources comprising of:
   I. Video Sessions
   II. Chat Sessions
   III. Audio Sessions
   IV. Blackboard Session
   V. Gaming Session

User X1, X2,X3,X4, Y1,Y2,Y3 and Y4 can perform their own interactions within their social network platforms in addition to participating in the collaborative sessions within their respective groups.

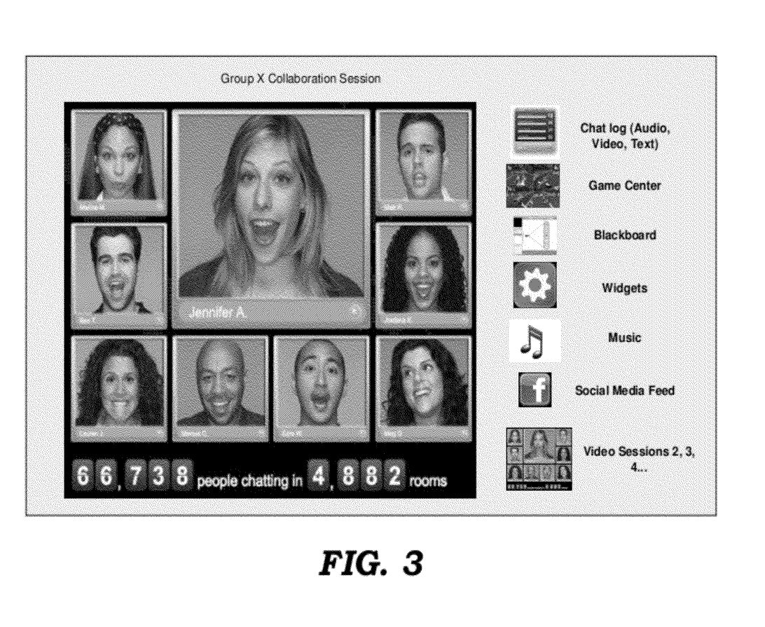

Another embodiment relates to User Session Collaboration Dimensions as shown in FIG. 3. The embodiments herein describes the features associated with each user session.

SWAP User A's two collaborative sessions are independent of each other. Group X's collaboration session from User A's perspective is illustrated in FIG. 3.

The highlights of the collaborative sessions include some or all of the following features:
1. The session is centered around each member's communication input (text, video, or audio)
2. The session can be manipulated using the tools available using some or all of the following features:
   I. Chat log—records the messages received during the session and saves it for later access. Can compress the session into a shorter version of the session in which the main events of the session are highlighted.
   II. Game Center—User has access to an application hub that allows users to download games that the entire session can participate in, while maintaining communication capabilities.
   III. Blackboard—User can add a virtual blackboard to the session in which documents can be uploaded for group editing, equations can be written out, or diagrams can be built collaboratively.
   IV. Widgets—Displays a list of available widgets within the SWAP domain such as

WolframAlpha, Wikipedia, Google.
V. Music—Users can either share music using this tool or import music from other applications such as iTunes.
VI. Social Media Feed—While members of a session are communicating, an individual user has the capability to access his or her own personal social media accounts.
VII. Users can access various other sessions that are concurrently running, or can being a new session entirely, separate from the members of the current group.

During the collaborative sessions each individual tool that is added to a session can be limited to simply the visibility of the user or available to the entire session.

Another embodiment relates to SWAP Reporting Features. One of the major challenges of recording multimedia assets such as video footage and audio footage is the size and the length of the recording. In general, when conversations occur for hours, the interesting events take place only during a few important snapshots of time. Also, when multiple conversations are occurring within a group it is difficult to distinguish between important conversations versus unimportant background noise.

The SWAP system will store these recordings in very efficient way and also will have the capability to overlay one media collaboration with other i.e. video, audio and text chatting can all be overlaid to create the synopsis of collaboration that has taken place at any important moment during these conversations. This will enable long collaboration recordings to be reduced to few minutes of important synopsis collaboration events.

Another embodiment relates to SWAP Conceptual Architecture. The SWAP system can be viewed as a system that includes multiple layers of functionality.

Each layer represents a category of functionality, for example, which could include the following:
1. Authentication/Authorization Layer: Responsible for handling user authentication and authorization.
2. Communication Framework Layer: Responsible for establishing communication between multiple user sessions.
3. Multimedia Management Layer: Responsible for establishing and managing multimedia functionality such as video, pictures, and audio sessions etc.
4. Social Networking Platform Layer: Responsible for establishing and managing sessions related to other collaboration platforms such as Facebook and Twitter etc.
5. Academic Application Layer: Responsible for establishing and managing external and internal applications relations to academic collaboration tools such as blackboard, Wolfram Alpha and other custom academic applications.
6. Gaming Application Layer: Responsible for establishing and managing gaming applications that participate in collaborative activities.
7. Advertising Application Layer: Responsible for establishing and managing advertisements to be displayed on the SWAP platform.
8. Reporting Management Layer: Responsible for recording and retrieving collaboration sessions including synopsis creation. This functionality enables users to overlay one media interaction with other media interactions and also to retrieve significant events within few seconds.
9. Another embodiment relates to SWAP logical architecture. SWAP logical architecture describes the major software components used for building the software system. The SWAP system can be accessed from multiple client devices including mobile, desktops and other servers.

The components associated with the SWAP system comprising the logical architecture could include:
1. User interface (UI) Component: Responsible for implementing user interface related logic. This component will implement the logic to handle multiple device interaction.
2. Integration Platform: This component is key to the functionality of the collaboration of the user sessions and the exchange of data between multiple sessions.

The subcomponents of the system could include some or all the following features:
1. Parse Framework: Responsible for interpreting the data from the user interface layer.
2. Intra Service Session Data Exchange: Responsible for the ability to use from one media component to be used in another media component. This component enables functionality such as the key words from audio chat can text chat etc.
3. Service Orchestration Engine: Responsible for invoking multiple components and waiting for responses from multiple sources. This component is key to managing the collaboration sessions between groups of users
4. Session Management Engine: Responsible for establishing starting, maintaining and ending user sessions gracefully.
5. Custom Application Development Platform: The component exposes the functionality of the system as a set of Application Programming Interface (APIs). These APIs can be used by other developers to implement their own custom applications.
6. Gaming Service Engine: Responsible for exposing APIs useful for creating new games. The developers can develop games using the engine APIs.
7. Reporting and Monitoring Services: Responsible for recording all key data elements associated with the user sessions. The recording will be done in an optimized fashion so that the reports can be archived and retrieved efficiently.
8. Proxy Service: Responsible for logging into external systems and transferring the data from external system.
9. Security Service: Responsible for protecting unauthorized users from accessing the system.

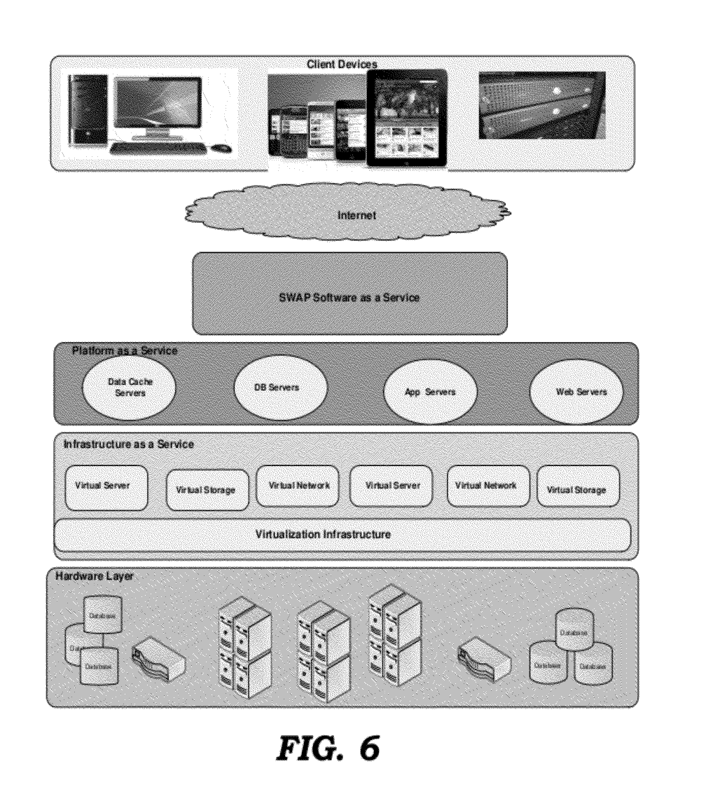

Another embodiment relates to the SWAP system's technical architecture. The SWAP software will be architected, designed and built to either deploy on traditional hardware and software or cloud based services. FIG. 6 illustrates the cloud based technical architecture. The SWAP system architecture is aligned to fully utilize the current cloud based services public, private and/or hybrid. A cloud includes virtualized servers, network and storage and is available as services so engineers can provision the necessary capacity based on their needs. In addition, the SWAP system will fully harness the readily available open source software platforms for developing custom services that include web servers, application servers, database servers, and in-memory cache servers etc. The SWAP system's technical architecture is aligned store and captures multiple users from multiple groups, agencies and organizations.

FIG. 6 illustrates SWAPs deployment platform architecture on a typical cloud platform. The functionality of each layer within a cloud layer is described below:

Hardware Layer: This layer includes physical hardware including servers, network devices and storage devices located geographically in different locations. They are all interconnected to act in unison to provide computing, storage and networking bandwidth.

Infrastructure as a Service Layer: This layer includes a multitude of virtual servers, virtual networks and virtual storage capacity that will run on the hardware layer. This architecture gives the flexibility to spin off new virtual machines dynamically based on load conditions. This virtualization combined with dynamic capabilities to launch new virtual servers gives the capability for SWAP to act like an elastic software that can increase its capacity increase or decrease based on usage.

Platform as a Service Layer: The standard software application deployment platforms such as Web Servers, Application Servers, and Caching Servers are hosted on virtual machines running on the infrastructure layer. Similar to Infrastructure Layer, the number of instances of these application deployment platforms will have the elastic characteristics to either increase or decrease capacity based on load conditions.

SWAP Software as a Service Layer: SWAP software will be developed as a cloud enabled software that can run on Cloud Platform as a Service Layer with the ability to dynamically launch new instances of SWAP software based on capacity requirements. In additions, its architecture will be suitable for hosting multiple user/group data without compromising privacy and security.

The SWAP software can be accessed from any device including mobile platforms as well as traditional desktop computers or servers. A set of highly optimized mobile apps will be developed and distributed through app stores.

An embodiment relates to accessing the collaborative interactive session in a manner such that a person or system can access an event from the collaborative interactive session in substantially less time than a duration of the collaborative interactive session. Such an embodiment may include audio and/or video synopsis of a collaborative interactive session for a plurality of members using a sound and image-processing technology that creates a summary of an original full length audio and/or video. The synopsis is made possible by simultaneously presenting multiple person's voices and/or objects and activities that have occurred at different times. Audio and/or video synopsis could enable the rapid review and indexing of captured audio and/or video footage—with an index to the original source audio and/or video; real-time audio and/or video feed online and archival audio and/or video footage offline—for on-the-spot event tracking, forensics and evidence discovery. Audio and/or video synopsis technology could provide a very short audio and/or video representation of a long time period, while preserving all essential sounds and movements of the original audio and/or video. The synopsis could serve as an index into the full audio and/or video, and could be performed in three stages.

In the ingest stage, the audio and/or video could be analyzed online as it is being recorded to the DVR/NVR, separated into background (all background noise and/or static, non-moving objects) and foreground (such as voice, music and/or moving objects), and the foreground extracted. Descriptions of the extracted foreground, e.g., an identifier for each person's voice and/or an identifier for each moving object, are inserted into a database.

In the synopsis stage, a user specifies a time period of interest (e.g. last 24 hours), and all relevant person's voices and/or objects and backgrounds for the specified period are extracted from database. A very short synopsis audio and/or video is generated from these voices and/or objects and backgrounds. The synopsis audio and/or video can be very short (a few minutes can summarize a full day) as voices and/or objects are shifted in time, and many voices and/or objects are heard and/or shown substantially simultaneously in a manner that the voices and objects are still discernable and in a highly compressed time period as compared to the time period of interest.

In the indexing stage, the user selects a person's voice and/or an object of interest during an interval within the time period of interest. This voice and/or object points to the original audio and/or video and this voice and/object is re-played as it has been recorded.

The Algorithm presented in the present example is but one of the possible algorithms to implement a virtual communications platform.

The present disclosure is not to be limited in terms of the particular embodiments described in this application, which are intended as illustrations of various aspects. Many modifications and variations can be made without departing from its spirit and scope, as could be apparent to those skilled in the art. Functionally equivalent methods and apparatuses within the scope of the disclosure, in addition to those enumerated herein, could be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods, reagents, compounds compositions or biological systems, which can, of course, vary. It is also to be understood that the terminology used herein is for the purpose of describing particular embodiments only, and is not intended to be limiting.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It could be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It could be further understood by those within the art that if a specific number of an introduced claim recitation is intended, such an intent could be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations. In addition, even if a specific number of an introduced claim recitation is explicitly recited, those skilled in the art could recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” is used, in general such a construction is intended in the sense one having skill in the art could understand the convention (e.g., “a system having at least one of A, B, and C” could include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art could understand the convention (e.g., “a system having at least one of A, B, or C” could include but not be limited to systems that have A alone, B alone, C alone, A and B together, A and C together, B and C together, and/or A, B, and C together, etc.). It could be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” could be understood to include the possibilities of “A” or “B” or “A and B.”

In addition, where features or aspects of the disclosure are described in terms of Markush groups, those skilled in the art could recognize that the disclosure is also thereby described in terms of any individual member or subgroup of members of the Markush group.

As could be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As could also be understood by one skilled in the art all language such as “up to,” “at least,” “greater than,” “less than,” and the like include the number recited and refer to ranges which can be subsequently broken down into subranges as discussed above. Finally, as could be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

While various aspects and embodiments have been disclosed herein, other aspects and embodiments could be apparent to those skilled in the art. The various aspects and embodiments disclosed herein are for purposes of illustration and are not intended to be limiting, with the true scope and spirit being indicated by the following claims.

### APPENDIX 1

The U.S. patents and publications listed below are hereby incorporated herein by reference in their entirety.
U.S. Pat. No. 8,102,406; Issue date: Jan. 24, 2102; Method and system for producing a video synopsis
U.S. Pat. No. 8,073,839; Issue date: Dec. 6, 2011; System and method of peer to peer searching, sharing, social networking and communication in one or more networks
U.S. Pat. No. 7,523,163; Issue date: Apr. 21, 2009; Distributed network system architecture for collaborative computing
U.S. Pat. No. 7,313,595; Issue date: Dec. 25 2007; System and method for record and playback of collaborative web browsing session
U.S. Pat. No. 7,236,926; Issue date: Jun. 26, 2007; System and method for voice transmission over network protocols
U.S. Pat. No. 6,567,813; Issue date: May 20, 2003; Quality of service maintenance for distributed collaborative computing
Publication number: US 2011/0258125; Filing date: Apr. 14, 2011; Collaborative social event planning and execution
Publication number: US 2011/0225519; Filing date: Feb. 16, 2011 Social media platform for simulating a live experience
Publication number: US 2011/0066664; Filing date: Sep. 15, 2010; Sports collaboration and communication platform
Publication number: US 2010/0299334; Filing date: Sep. 8, 2009; Computer implemented system and method for providing a community and collaboration platform around knowledge transfer, expertise, innovation, tangible assets, intangible assets and information assets
Publication number: US 2010/0332616; Filing date: Aug. 31, 2009; Web guide Publication number: US 2010/0262550; Filing date: Apr. 8, 2009; Inter-corporate collaboration overlay solution for professional social networks
Publication number: US 2009/0094039; Filing date: Oct. 4, 2007; Collaborative production of rich media content
Publication number: US 2008/0297588; Filing date: May 31, 2007, Managing scene transitions for video communication
Publication number: US 2005/0198141; Filing date: Feb. 4, 2005; Secure communications system for collaborative computing
Publication number: US 2003/0167304; Filing date: Dec. 29, 2000; Distributed meeting management
Publication number: US 2003/0164853; Filing date: Dec. 29, 2000; Distributed document sharing

1. A method of establishing a collaborative platform comprising performing a collaborative interactive session for a plurality of members, wherein some or all of the plurality of members from different human interaction platforms interact via the collaborative platform.

2. The method of claim 1, further comprising initiating collaborative interactive session that comprises initiating multiple collaborative interactive sessions.

3. The method of claim 1, further comprising accessing the collaborative interactive session in a manner such that a person or system can access an event from the collaborative interactive session in substantially less time than a duration of the collaborative interactive session.

4. The method of claim 1, further comprising displaying of targeted advertisements or notifications based on the context of the interactive collaborative sessions.

5. The method of claim 5, further comprising measuring effectiveness of the displaying of targeted advertisements or notifications.

6. The method of claim 2, wherein members of different multiple collaborative interactive sessions are isolated from each other while each member has a capability to simultaneously maintain the multiple collaborative interactive sessions.

7. The method of claim 1, further comprising integrating an application or a device within the collaborative interactive session.

8. A computer implemented system comprising:
a storage medium configured to store a collaborative interactive session data; and a processor configured to perform a collaborative interactive session for a plurality of members, wherein some or all of the plurality of members from different human interaction platforms interact via the collaborative interactive session, wherein the different human interactions platforms comprise social media platforms.

9. The system of claim 8, wherein the system is further configured to initiate collaborative interactive session that comprises initiating multiple collaborative interactive sessions.

10. The system of claim 8, wherein the system is further configured to initiate the collaborative interactive session in a manner such that a person or system can access an event from the collaborative interactive session in substantially less time than a duration of the collaborative interactive session.

11. The system of claim 8, wherein the system is further configured to display targeted advertisements or notifications based on the context of the interactive collaborative sessions.

12. The system of claim 12, wherein the system is further configured to measure effectiveness of the displaying of targeted advertisements or notifications.

13. The system of claim 9, wherein members of different multiple collaborative interactive sessions are isolated from each other while each member has a capability to simultaneously maintain the multiple collaborative interactive sessions.

14. The system of claim 8, wherein the system is further configured to integrate an application or a device within the collaborative interactive session.

15. A tangible non-transitory computer readable medium comprising computer executable instructions executable by one or more processors for establishing a collaborative platform comprising performing a collaborative interactive session for a plurality of members, wherein some or all of the plurality of members interact from different human interaction platforms.

16. The tangible non-transitory computer readable medium of claim 15, wherein the performing the collaborative interactive session comprises initiating multiple collaborative interactive sessions.

17. The tangible non-transitory computer readable medium of claim 15, further comprising computer executable instructions executable by one or more processors for accessing the collaborative interactive session in a manner such that a person or system can access an event from the collaborative interactive session in substantially less time than a duration of the collaborative interactive session.

18. The tangible non-transitory computer readable medium of claim 1, further comprising computer executable instructions executable by one or more processors for displaying of targeted advertisements or notifications based on the context of the interactive collaborative sessions.

19. The system of claim 8, wherein the system comprises a sound and/or video hub, wherein the sound and/or video hub allows any member of the plurality of the members to play a song and/or a video and simultaneously allows some or all of the plurality of members to listen and/or watch the song and/or the video played.

20. The system of claim 10, wherein the system comprises audio and/or video synopsis of the collaborative interactive session for the plurality of members using a sound and image-processing technology that creates a summary of an original full length audio and/or video.
